(19) United States
(12) Patent Application Publication
(10) Pub. No.: US 2018/0302343 A1
(43) Pub. Date: Oct. 18, 2018

(54) SYSTEM AND METHOD FOR CONVERGENCE OF SOFTWARE DEFINED NETWORK (SDN) AND NETWORK FUNCTION VIRTUALIZATION (NFV)

(71) Applicant: ARGELA YAZILIM VE BILISIM TEKNOLOJILERI SAN. VE TIC. A.S., ISTANBUL (TR)

(72) Inventors: ERHAN LOKMAN, ISTANBUL (TR); ONUR KOYUNCU, ISTANBUL (TR); EROL OZCAN, ISTANBUL (TR); SINAN TATLICIOGLU, ISTANBUL (TR); SEYHAN CIVANLAR, ISTANBUL (TR)

(21) Appl. No.: 15/488,415

(22) Filed: Apr. 14, 2017

(51) Int. Cl. H04L 12/931; G06F 9/455; G06F 9/50; H04L 12/24; H04L 12/741; H04L 12/771; H04L 12/803; H04L 12/851

(52) U.S. Cl. CPC H04L 49/70; G06F 9/45533; G06F 9/5077; H04L 41/145; H04L 47/2441; H04L 45/745; H04L 45/56; H04L 47/125; H04L 41/0803

(57) ABSTRACT

When network function virtualization (NFV) is overlaid on top of a SDN, a convergence gateway mediates between the NFV orchestrator and the SDN controller. The convergence gateway collects from the orchestrator the information on the workload and up/down status of virtualized network functions that run on SDN's physical resources, and passes such information to the controller. The controller then makes an intelligent decision regarding optimally routing data flows for service chaining, choosing from many available virtualized functions along the data path. Reciprocally, the convergence gateway collects, from the controller, the network congestion and available capacity information on all physical and virtualized network resources of the SDN, and feeds that information to the orchestrator. Accordingly, the orchestrator decides on where and when to activate/deactivate/capacitate virtual functions to best serve a service request. An information model based approach is also presented for information sharing across the orchestrator, convergence gateway and controller.

### BACKGROUND OF THE INVENTION

### Field of Invention

The present invention relates to a system and a method designed for routing across many Virtualized Network Functions (VNFs) over a Software Defined Network (SDN).

### Discussion of Related Art

Any discussion of the prior art throughout the specification should in no way be considered as an admission that such prior art is widely known or forms part of common general knowledge in the field.

Network Function Virtualization (NFV) network decouples network functions from the underlying hardware so that they run as software images on commercial off-the-shelf and purpose-built hardware. It does so by using standard virtualization technologies (networking, computation, and storage) to virtualize the network functions. The objective is to reduce the dependence on dedicated, specialized physical devices by allocating and using the physical and virtual resources only when and where they're needed. With this approach, service providers can reduce overall costs by shifting more components to a common physical infrastructure while optimizing its use, allowing them to respond more dynamically to changing market demands by deploying new applications and services as needed. The virtualization of network functions also enables the acceleration of time to market for new services because it allows for a more automated and streamlined approach to service delivery.

NFV uses all physical network resources as hardware platforms for virtual machines on which a variety of network-based services can be activated and deactivated on an as needed basis. An NFV platform runs on an off-the-shelf multi-core hardware and is built using software that incorporates carrier-grade features. The NFV platform software is responsible for dynamically reassigning VNFs due to failures and changes in traffic loads, and therefore plays an important role in achieving high availability.

Key Virtualized Network Functions (VNF) that emulate an enterprise's Customer Premises Equipment (CPE) capabilities within the core network are VPN termination, Deep Packet Inspection (DPI), Load Balancing, Network Address Translation (NAT), Firewall (FW), QoS, email, web services, and Intrusion Prevention System (IPS), just to name a few. These are functions typically deployed today within or at the edges of an enterprise network on dedicated hardware/server infrastructure where it may be more appropriate for a service provide to deliver as virtualized network functions. The general principles of such virtualization can increase the flexibility by sharing resources across many enterprises and decrease setup and management costs. The service provider can make available a suite of infrastructure and applications as a ‘platform’ on which the enterprise can themselves deploy and configure their network applications completely customized to their business needs.

A key software component called ‘orchestrator’, which provides management of the NFV services is responsible for on-boarding of new network services and virtual network function (VNF) packages, service lifecycle management, global resource management, and validation and authorization of NFV resource requests. Orchestrator must communicate with the underlying NFV platform to instantiate a service. It performs other key functions:
Replicates services to scale for either a single customer or many customers;
Finds and manages sufficient resources to deliver the service;
Tracks performance to make sure they are adequate.

Orchestrator can remotely activate a collection of virtual functions on a network platform. Doing so, it eliminates the need for deployment of complex and expensive functions at each individual dedicated CPE by integrating them in a few key locations within the provider's network. ETSI provides a comprehensive set of standards defining NFV Management and Orchestration (MANO) interface in various standards documents. For example, the Orchestrator to VNF interface is defined as the Ve-Vnfm interface. There are several other interfaces that tie NVF to the Operations Systems (OSS) and Business Systems (BSS) systems. All of these interfaces and their functions are publically available in ETSI NVF Reference Architecture documents in ETSI's web pages.

In the past, servers that host the aforementioned services would physically connect to a hardware-based switch located in the data center. Later, with the advent of the concept of ‘server virtualization’ an access layer is created that changed the paradigm from having to be connected to a physical switch to being able to connect to a ‘virtual switch’. This virtual switch is only a software layer that resides in a server that is hosting many virtual machines (VMs). VMs, or containers, have logical or virtual Ethernet ports. These logical ports connect to a virtual switch. The Open vSwitch (OVS) is the commonly known access layer software that enables to run many VMs in a single server.

Programmable networks such as Software Defined Networks (SDN) provide yet another new physical network infrastructure in which the control and data layers are separated wherein the data layer is controlled by a centralized controller. The data layer is comprised of so-called ‘switches’ (also known as ‘forwarders’) that act as L2/L3 switches receiving instructions from the centralized ‘controller’ using a north-south interface, also known as OpenFlow. Network Function Virtualization (NFV), in combination with Software Defined Networking (SDN) promises to help transform today's service provider networks. It will transform how they are deployed and managed, and the way services are delivered to customers. The ultimate goal is to enable service providers to reduce costs, increase business agility, and accelerate the time to market for new services.

While VNFs are instantiated and managed by the NFV Orchestrator, the data flows between these VNFs and other network elements (network switches and hosts) are manipulated by the SDN controller. Therefore, the orchestrator and the controller essentially need to cooperate in delivering different aspects of the service to the users. For example, the forwarding actions applied to the packet flows to ensure that data flows not only travel through the switch towards a destination but also pass through certain virtualized network functions in a specific order becomes the task of the controller. On the other hand, if a specific virtualized service runs out of capacity or can't be reached because of a network failure or congestion, activating a new service component becomes the task of the orchestrator. This patent application is primarily concerned with effective and rapid interaction between an SDN with many distributed VNFs deployed across network resources of that SDN for both routing and capacity management.

A VNF Forwarding Graph is a prior-art concept defined in ETSI standards documents on Network Functions Virtualization (NFV). It is the sequence of virtual network functions that packets traverse for service chaining. It essentially provides the logical connectivity across the network between virtual network functions. An abstract network service based on a chain of VNFs must include identification and sequencing of different types of VNFs involved, and the physical relationship between those VNFs and the interconnection (forwarding) topology with those physical network functions such as switches, routers and links to provide the service. Some packet flows may need to visit specific destination(s) (e.g., a set of VNFs) before the final destination, while others may only have a final Internet destination without traversing any VNFs.

Using the definitions provided in the ETSI standards, referenced above, we will use the following nomenclature for SDN based NFV, which will come in handy describing key embodiments of this invention:

SDN Function: A physical software defined network implementation that is part of an overall service that is deployed, managed and operated by an SDN provider. This more specifically means a switch, router, host, or facility.

SDN Switch: A networking component performing L2 and L3 forwarding based on forwarding instructions from the network controller.

SDN Switch Port: A physical port on an SDN function, such as a network interface card (NIC). It is identified by an L2 and L3 address.

VNF Virtual Port: A virtual port identifying a specific VNF (also denoted as VNIC) in a virtual machine (VM). This port can be mapped into a NIC of the physical resource hosting the service.

NFV Network Infrastructure: It provides the connectivity services between the VNFs that implement the forwarding graph links between various VNF nodes.

SDN Association: The association or mapping between the NFV Network Infrastructure (virtual) and the SDN function (physical).

Forwarding Path: The sequence of switching ports (NICs and VNICs) in the NFV network infrastructure that implements a forwarding path.

Virtual Machine (VM) Environment: The characteristics of computing, storage and networking environments for a specific set of virtualized network functions.

Network Node: A grouping of network resources hosting one or more virtual services (e.g., servers), and an SDN switch that are physically collocated.

One of the key requirements to enable NFV over SDN is ‘SDN association’, which is simply the mapping between the virtualized functions and SDN's physical functions. Information modeling is one of the most efficient ways to model such mappings. Entries in that Information Model must capture the dynamically changing nature of the mappings between the virtual and physical worlds as new virtual machines are activated, and existing virtual machines become congested or down. Furthermore, it must enable the controller to determine forwarding graphs rapidly, and in concert with the orchestrator.

Modeling a network using object-oriented notation is well understood in prior art. For example, Common Information Model (CIM) developed by the Distributed Management Task Force (DMTF) has been gradually building up for over a decade and contains many object representations of physical network functions and services. To mention a few: network, switch, router, link, facility, server, port, IP address, MAC address, tag, controller as well as service-oriented objects such as user, account, enterprise, service, security service, policy, etc. Inheritance, association and aggregation are prior-art mechanisms used to link objects to one another. The information model describes these links as well. In addition to CIM, there are other similar prior art information models used to model networks and services.

The NFV over SDN must map a customer/enterprise's specific overall service request to a single service or a chain of services (also known as service function chaining), and these chain of services to specific virtualized network functions and those to functions specific physical network resources (switches, hosts, etc.) on which the service will be provided. Fortunately, an information model such as CIM provides the schema to model the proper mappings and associations, possibly without any proprietary extensions in the schema. This information model allows a comprehensive implementation within a relational database (e.g., Structured Query Language—SQL) or hierarchical directory (e.g., Lightweight Directory Access Protocol—LDAP) parts of which may be replicated and distributed across the controller, orchestrator and the system of invention called convergence gateway according to an aspect of this invention. Doing so, the network control (SDN/controller) and service management (NFV/orchestrator) operate in complete synchronicity and harmony. A publish-subscribe (PubSub) model, well known in prior art, may be appropriate to distribute such a large-scale and comprehensive information across two or more systems to provide sufficient scalability and dynamicity, in which case a database maybe more appropriate than a directory.

Embodiments of the present invention are an improvement over prior art systems and methods.

### SUMMARY OF THE INVENTION

In one embodiment, the present invention provides a system comprising: (a) a convergence gateway attached to a controller that is part of a software defined network (SDN), the controller controlling a plurality of network switches that are part of the SDN, with a first network switch connected to a first host and a second network switch connected to a second host; (b) one or more virtualized network functions (VNFs) associated with each of the network switches; (c) an orchestrator managing the VNFs, wherein the convergence gateway performs: (1) collecting and storing data pertaining to: (i) status of the network switches and one or more links interconnecting the network switches forming a topology of the SDN, and network congestion and available capacity information on all physical and virtualized network resources of the SDN; (ii) VNFs associated with each of the network switch, and data relating to capacity and congestion status associated with each VNF; and (2) determining a routing path via any one of the following ways: (i) of at least one packet flow between the first host and second host, where the routing path traverses, as part of the packet flow between the first host and second host, at least one of the network switches and at least one of the VNFs; (ii) determining a routing path of at least one packet flow between either the first or second host and a requested VNF, where the routing path traverses, as part of the packet flow between either the first or second host and the requested VNFassociated with one of the network switches; or (iii) determining a routing path of at least one packet flow between either the first or second host and a first VNF, where the routing path traverses, as part of the packet flow between either the first second host and the first VNF, at least one of the network switches and a second requested VNF associated with that switch.

In another embodiment, the present invention provides a method as implemented in a convergence gateway attached to a controller that is part of a software defined network (SDN), the controller controlling a plurality of network switches that are part of the SDN, the network switches associated with one or more virtualized network functions (VNFs), the VNFs being managed by an orchestrator, with a first network switch connected to a first host and a second network switch connected to a second host, the method comprising: (a) collecting and storing data pertaining to: (i) status of the network switches and one or more links interconnecting the network switches forming a topology of the SDN, and network congestion and available capacity information on all physical and virtualized network resources of the SDN; (ii) VNFs associated with each of the network switch, and data relating to capacity and congestion status associated with each VNF; and (b) determining a routing path via any one of the following ways: (i) of at least one packet flow between the first host and second host, where the routing path traverses, as part of the packet flow between the first host and second host, at least one of the network switches and at least one of the requested VNFs; (ii) determining a routing path of at least one packet flow between either the first or second host and a requested VNF, where the routing path traverses, as part of the packet flow between either the first or second host and the requested VNF, collocated with one of the network switches; or (iii) determining a routing path of at least one packet flow between either the first or second host and a first VNF, where the routing path traverses, as part of the packet flow between either the first second host and the first VNF, at least one of the network switches and a second requested VNF associated with that switch.

In yet another embodiment, the present invention provides an article of manufacture having non-transitory computer readable storage medium comprising computer readable program code executable by a processor in a convergence gateway attached to a controller that is part of a software defined network (SDN), the controller controlling a plurality of network switches that are part of the SDN, the network switches associated with one or more virtualized network functions (VNFs), the VNFs being managed by an orchestrator, with a first network switch connected to a first host and a second network switch connected to a second host, the medium comprising: (a) computer readable program code collecting and storing data pertaining to: (i) status of the network switches and one or more links interconnecting the network switches forming a topology of the SDN, and network congestion and available capacity information on all physical and virtualized network resources of the SDN; (ii) VNFs associated with each of the network switch, and data relating to capacity and congestion status associated with each VNF; and (b) computer readable program code determining a routing path via any one of the following ways: (i) of at least one packet flow between the first host and second host, where the routing path traverses, as part of the packet flow between the first host and second host, at least one of the network switches and at least one VNF; (ii) determining a routing path of at least one packet flow between either the first or second host and a requested VNF, where the routing path traverses, as part of the packet flow between either the first or second host and the requested VNF associated with one of the network switches; or (iii) determining a routing path of at least one packet flow between either the first or second host and a first requested VNF, where the routing path traverses, as part of the packet flow between either the first second host and the first requested VNF, at least one of the network switches and a second requested VNF associated with that switch.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an exemplary SDN and NFV integrated with the system of the invention.

FIGS. 2A-2B illustrate two forwarding graphs in an SDN.

FIGS. 3A-3B illustrate a network node and the modeling of a network node according to an embodiment of the invention.

FIG. 4 illustrates an exemplary information model of the convergence gateway.

FIGS. 5A-5D illustrate different embodiments of the convergence gateway.

FIG. 6 depicts a block diagram of the controller with a resident convergence gateway.

FIG. 7 shows an exemplary network designed for the use-case of routing for service chaining.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device (e.g., a router, switch, orchestrator, hardware platform, controller etc.) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, router, controller, orchestrator, server or convergence gateway is a piece of networking component, including hardware and software that communicatively interconnects with other equipment of the network (e.g., other network devices, and end systems). Switches provide network connectivity to other networking equipment such as switches, gateways, and routers that exhibit multiple layer networking functions (e.g., routing, bridging, VLAN (virtual LAN) switching, layer-2 switching, Quality of Service, and/or subscriber management), and/or provide support for traffic coming from multiple application services (e.g., data, voice, and video). Any physical device in the network is generally identified by its type, ID/name, Medium Access Control (MAC) address, and Internet Protocol (IP) address.

Note that while the illustrated examples in the specification discuss mainly NFV (as ETSI defines) relying on SDN (as Internet Engineering Task Force [IETF] and Open Networking Forum [ONF] define), embodiments of the invention may also be applicable in other kinds of distributed virtualized network function architectures and programmable network architectures, not necessarily tied to NFV and SDN.

When many virtualized network services (VNF) are available on a software defined network (SDN), the controller has to route traffic destined to these virtualized services that are dynamically activated/deactivated using physical network resources of the network. Doing so, it tries to meet the required capacity and performance requirements according the service level agreement of a customer's packet flow. When certain routes of an SDN are congested, the reachability to some VNFs will be severely limited—although those VNFs can perfectly provide the required workload for the requested service. Similarly, when certain VNFs are overworked, even though the paths to these VNFs are not overloaded the SDN controller has to divert the packet flows towards other idle VNFs offering the same service elsewhere in the network. Therefore, it is impossible to treat routing for NVF and SDN in a vacuum, i.e., in a completely decoupled manner. Any network switch can be instantly transformed into a platform of new VNFs upon new service needs and traffic conditions in the network. Automating the determination and selection of an optimal physical location and platform on which to place the VNFs, depending on network conditions and various business parameters such as cost, performance, and user experience, is a key benefit. A VNF can be placed on various devices in the network—in a data center, in a network node adjacent to a switch, or even on the customer premises.

There are other conditions such as emergencies (earthquakes, tsunamis, floods, wars, etc.) that may require hauling of major blocks of VNFs to other regions/parts of the physical networks, in which case the NFV network infrastructure and topology changes completely. All these facts create an important need for NFV-aware operations within an SDN and SDN-aware operations in NFV both of which are the topics of this invention.

In an embodiment of this invention, system called convergence gateway, and a method is deployed that mediates between (a) the orchestrator, which controls and monitors VNFs, and (b) the SDN controller, which controls network routing and monitors physical network performance. Convergence gateway acts essentially as an adaptation-layer enabling the minimal level of coupling between the two infrastructures that share information without necessarily sharing all resource data of their respective domains. Particularly, in service function chaining wherein a cascade of VNFs located in different places in the network, the mediation described in this invention allows a different forwarding graph topology than simply the default routing topology, such as shortest path.

The creative aspect of the convergence gateway is that it exploits an efficient information model sharing between the orchestrator and controller to mutually trigger changes knowing one another's infrastructure. In one embodiment, the information model is derived from prior art Common Information Model (CIM). According to one aspect of this invention, the controller determines the most efficient forwarding graph to reach the VNFs (not always on the shortest path between the source and destination) to successfully serve the packet flow using the information obtained from the system of invention.

In patent application 2016/0080263 A1 Park et al. describes a method for service chaining in an SDN in which a user's service request is derived by the controller from a specific service request packet, which is forwarded by the ingress switch to the controller in a packet-in message. Using a database with a service table, a user table, and a virtualized network functions table, which are all statically associated with one another, the controller determines the forwarding of user's packet. The orchestrator may send updated information on virtualized functions to the controller. However, this patent application does not teach a system that mediates between the orchestrator and controller allowing two-way communications. It does not teach how the controller dynamically selects from a pool of VNFs in the network that is offering the same service. Furthermore, our patent application teaches a method by which a switch and the VNFs collocated with that network switch can be grouped as a ‘network node’ inter-connected with virtual links.

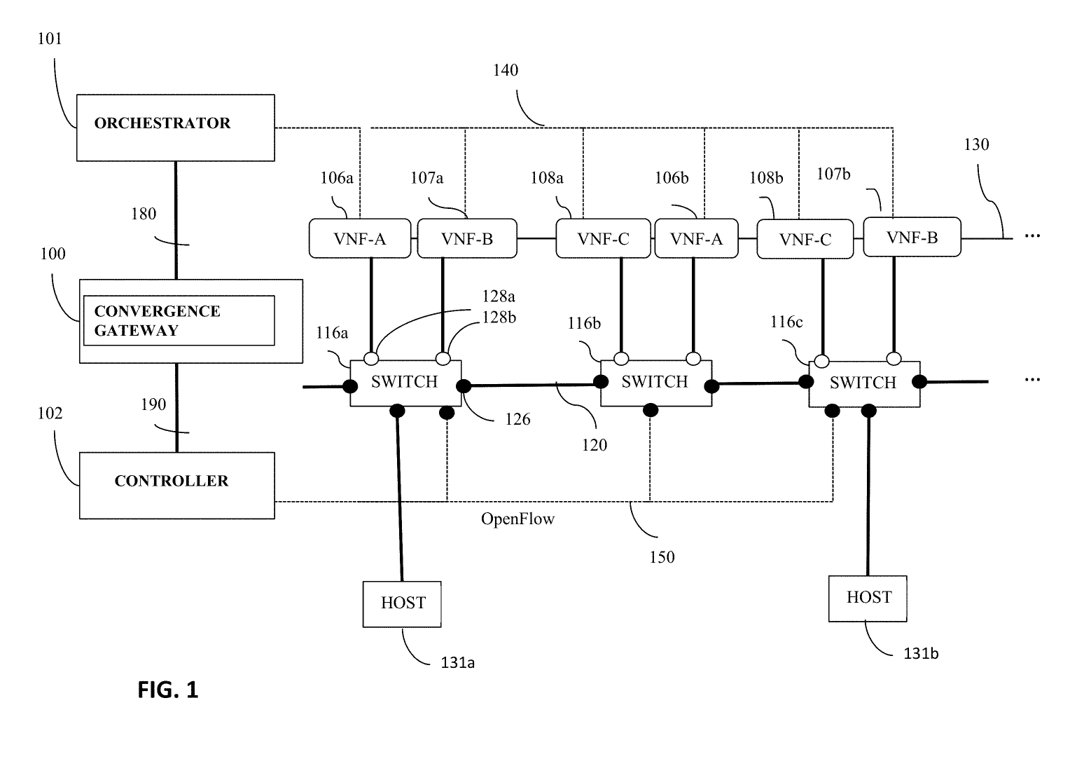

FIG. 1 illustrates a simple SDN with an overlaid NFV infrastructure in which the system of invention is illustrated. The network is comprised of several VNFs actively operating in a network node (these VNFs may physically reside on the switch hardware or on adjunct servers that connect to the switch). There are three different types of virtualized network functions, namely VNF-A (Encryptor), VNF-B (Load Balancer) and VNF-C(Network Address Translator) which are distributed across three switching nodes: Switching node 116a hosts VNF-A 106a, and VNF-B 107a, switching node 116b hosts VNF-C 108a and VNF-A 106b, and switching node 116c hosts VNF-C 108b and VNF-B 107b. Note that orchestrator 101 manages VNFs 106a,b, 107a,b and 108a,b using MANO interface 140, while controller 102 manages network switches 116a, 116b and 116c using north-south bound interface (e.g., OpenFlow) 150.

Convergence gateway 100, the system of the invention, is attached to both orchestrator 101 and controller 102, with network connections 180 and 190, respectively. Hosts 131a and 131b are attached to switches 116a and 116c respectively, receiving both transport (routing) and services (NAT, Encryption, etc.) from the network. Hosts are personal computers, servers, workstations, super computers, cell phones, etc. On switch 116a, NIC 126, and VNIC 128a,b, which virtually connect VNF-A and VNF-B to the switch are illustrated. VNIC 128a and 128b have unique IP addresses and physically map a NIC on the switch such as NIC 126. Also shown, in FIG. 1 is facility 120 that interconnects switches 116a and 116b. For the sake of simplicity, not all ports and facilities are labeled.

In an SDN with NFV, the data flows originated from a host (user terminal) can be classified as follows:

a) Flows destined to another host without any VNF visitations;

b) Flows destined to a specific VNF (such as an email or web services); and

c) Flows destined to another host via one or more VNFs visited along the way first (such as NAT and Firewall).

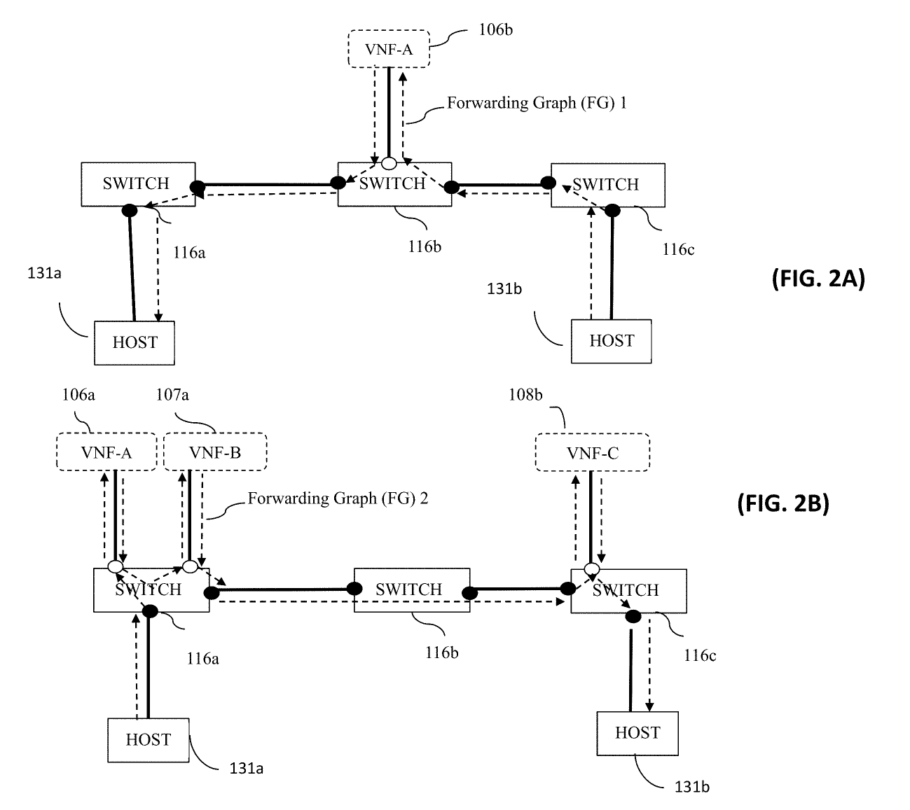

Just to illustrate the most complex case of c) above, FIGS. 2A and 2B are provided to illustrate two forwarding graphs traversing different set of functions across the network of FIG. 1. In FIG. 2A, Host 131b sends traffic towards host 131a using service of VNF-A along the way. The Forwarding Graph (FG)-1 travels from switch 116c towards 116b first. Then, switch 116b routes the traffic (a) first to VNF-A 106b, then (b) second to switch 116a. These two steps are accomplished in an ordered sequence. Finally, when switch 116a receives the traffic, it routes the traffic towards Hosts 131a.

In FIG. 2B, a more complicated scenario is illustrated. Host 131a sends traffic towards Host 131b using the services of VNF-A and VNF-B along the way. Since the closest services available to Host 131a are 106a and 107a, the Forwarding Graph (FG)-2 travels towards switch 116a, and then from the switch towards 106a first, and towards 107a second, in that ordered sequence. The flow is then sent towards the final destination traversing switches 116b and 116c, in that ordered sequence. Finally, when switch 116c receives the traffic, it routes it towards Hosts 131b. The VNICs and NICs are illustrated on both figures to show the exact forwarding sequence.

Notice that the Forwarding Graph-1 and Forwarding Graph-2 take different routes on the NFV network infrastructure although they are representing two flows that are between the same host pair and traversing the same physical resources in the SDN network. Therefore, the ‘SDN associations’ of these two Forwarding Graphs are completely different. A method of this invention is to generate the Forwarding Graphs for different traffic flows that use virtualized network resources by taking account (a) the SDN network, (b) SDN network resources availability, (b) the NFV network infrastructure and topology, and (c) the NFV resources capacity and availability.

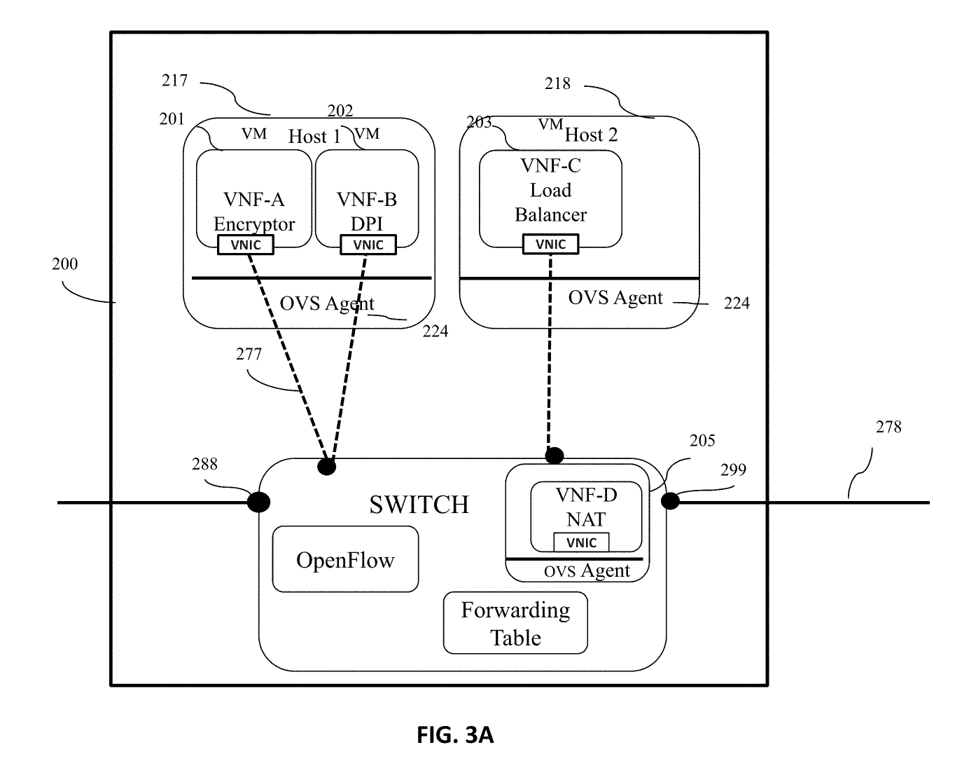

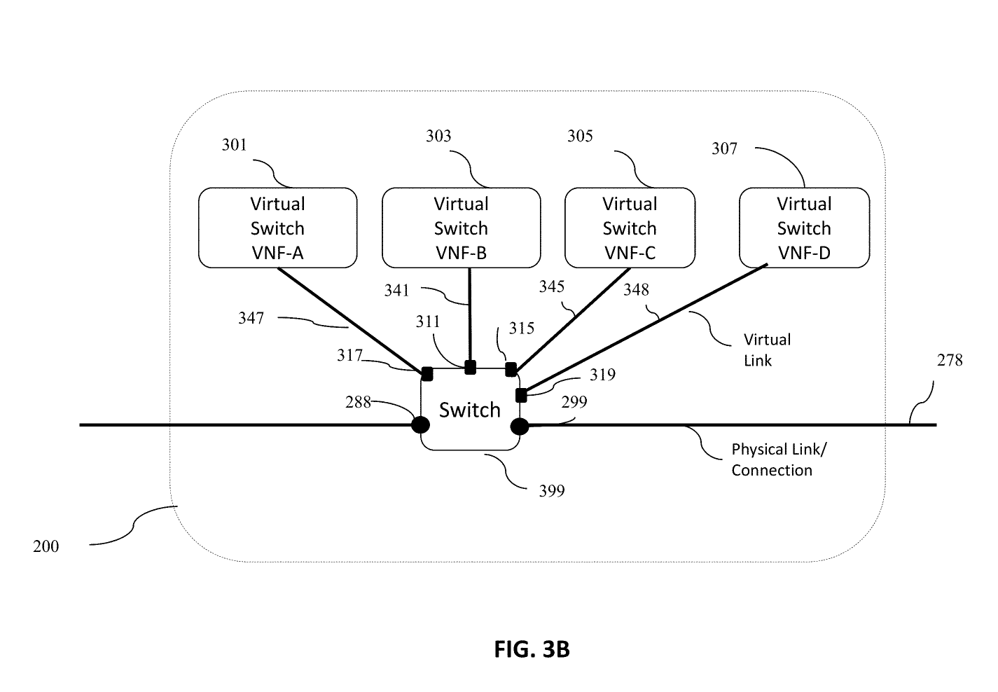

FIG. 3 illustrates an embodiment of a simple model to map VNFs into the world of SDN. Each VNF residing on a physical network resource is represented with a virtual port, and a virtual NIC (VNIC) that has a unique IP address. Doing so, any SDN switch with one or more active VNF functions is basically converted into two-tiers, wherein the switch is in the center is tier-1 and represents the network switch with many NICs and associated MAC-IP addresses. Each individual VNF function is at tier-2 and modeled with a ‘virtual link’ forming a star topology as illustrated in FIG. 3. Each co-resident VNF attaches to the center switch with a VNIC signifying the termination of the virtual link on the network switch. The length of a virtual link is assumed to be infinitesimal. These new concepts will be used forming the forwarding graph and the associated forwarding rules. The integration of VNF into SDN with a virtual port enables us to classify
VNF with a heavy workload as a ‘congested link’,
VNF with a light workload as an ‘idle link’,
VNF with a high processing capacity as a ‘high capacity link’,
VNF with small processing capacity as a ‘low capacity link’,
The closest VNF to a switch distance wise is its local VNF.

This simple modeling allows the routing across VNFs to be treated just like routing across a physical switched network with switches and connections. A packet flow entering the switch (the physical resource) first travels the center switch in which a forwarding action for that flow is typically specified. If there are no VNF applicable to that specific flow, then the flow is sent directly to an outgoing port of the switch towards the next hop switch according to a forwarding rule specified by the controller. Otherwise, the packet flow traverses one or more virtual switches, in a specific order according to requested service chaining, before getting out, and then back to the center switch in which there is the forwarding action towards the next hop network switch. The key distinction between a virtual switch and the network switch is that while the network switch performs forwarding according to rules provided by the controller between any of its physical port pair, the virtual switch has only a single port (aka VNIC) through which it can receive and send traffic.

FIG. 3A illustrates network node 200 with co-resident VNF-A 201, VNF-B 202, VNF-C 203 and VNF-D 205. VNF-A 201 and VNF-B 202 reside on host 217, VNF-C 203 on host 218, and VNF-D 205 on network switch 200. Hosts 217 and 218 and the network switch are all running an OVS agent creating on-board virtual machines (VMs) which are containers on which these functions run. Each function has a VNIC. Switch 200 has two NICs, 288 and 299. Facility 278 attaches to port 299. Using the concepts described above, VNF-A, B, C and D are modeled as virtual switches 301, 303, 305 and 307, respectively. These switches attach to center switch 399 with links 347, 341, 345, and 348 at VNICs 311, 315, 317 and 319. The topology of the equivalent two-layer network node 200 is illustrated in FIG. 3B. Note that center switch 399 has two NICs and four VNICs to forward across.

In one embodiment, the SDN controller knows the complete topology of the network with the physical and virtual resources and their associations; it has to receive information about the location and status of VNFs from the orchestrator through the system of invention. Similarly, the orchestrator knows about the status of network so that it can activate/deactivate VNFs according to current network conditions. The convergence gateway may be directly connected to the orchestrator and controller so that it can receive periodic or event-driven data updates from these two systems. Alternatively, it may use a bus-based interface for a publish-subscriber based data sharing. The convergence gateway can be modeled as a simple secure database with interfaces to the two systems, and a dictionary that translates data elements from one information model to another, if the two systems use different information models.

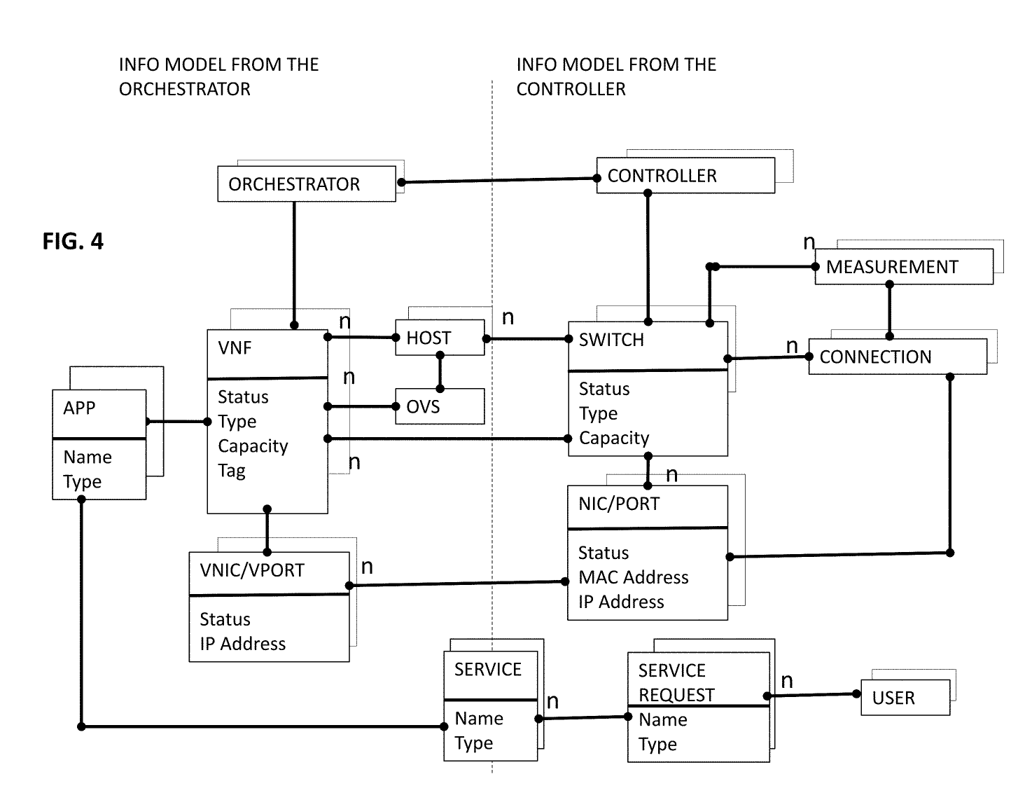

In FIG. 4, a simplified diagram of key information model components stored in the convergence gateway is illustrated. The objects shown on the right-hand side are obtained directly from the controller (and hence physical network related) and those on the other side are obtained from the orchestrator (and hence virtual services related). A few key attributes of each object are also illustrated just to ease the understanding of the object. The relationships between the objects are shown as possible examples as well. Note that the controller has an object called ‘service request’ which is comprised of several service elements, and tied into a user. Similarly, ‘service’ object exists in the orchestrator and ties into many VNFs spread across the SDN. Each VNF is associated with a VPORT (or VNIC), which is in turn associated with a PORT (or NIC) in a physical resource. Switch, Connection and PORT are linked, while a host is linked to a user for a simple model.

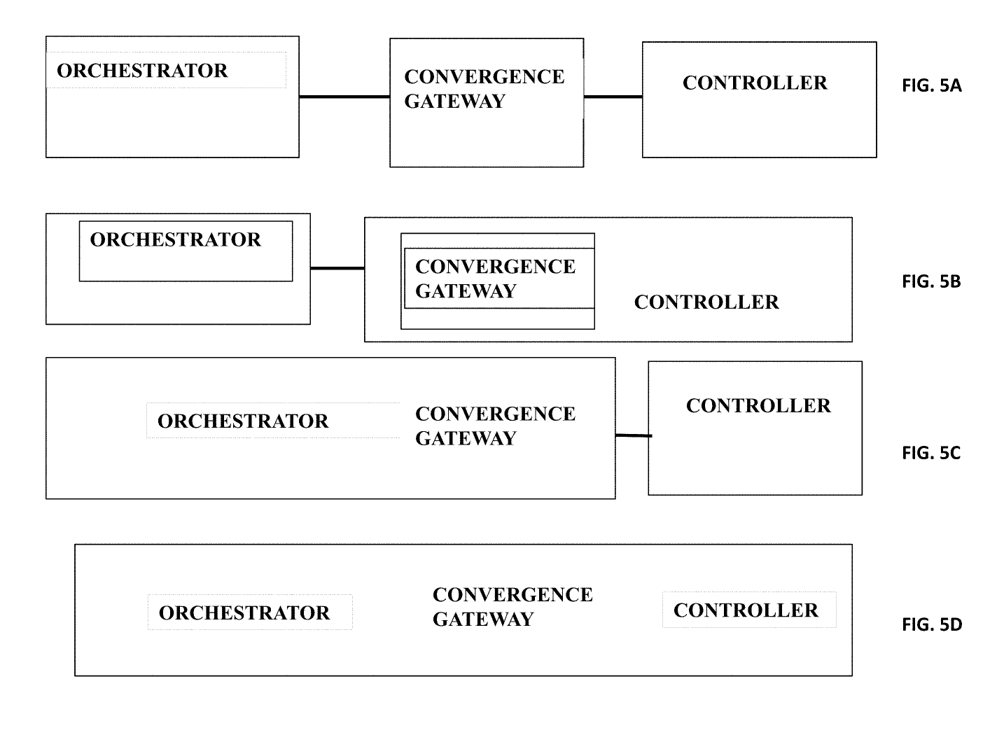

There are various embodiments of the convergence gateway as illustrated in FIGS. 5A-5D. Although it can be implemented as a standalone component attached to the orchestrator and controller via external interfaces as shown in FIG. 5A, it can also be an integral part of the orchestrator or the controller as illustrated in FIG. 5B and FIG. 5C. The interfaces of the convergence gateway are secure interfaces, using, for example, TCP/TLS. FIG. 5D illustrates an embodiment of an ‘all-in-one-box’ wherein controller, orchestrator and convergence gateway are implemented on the same hardware.

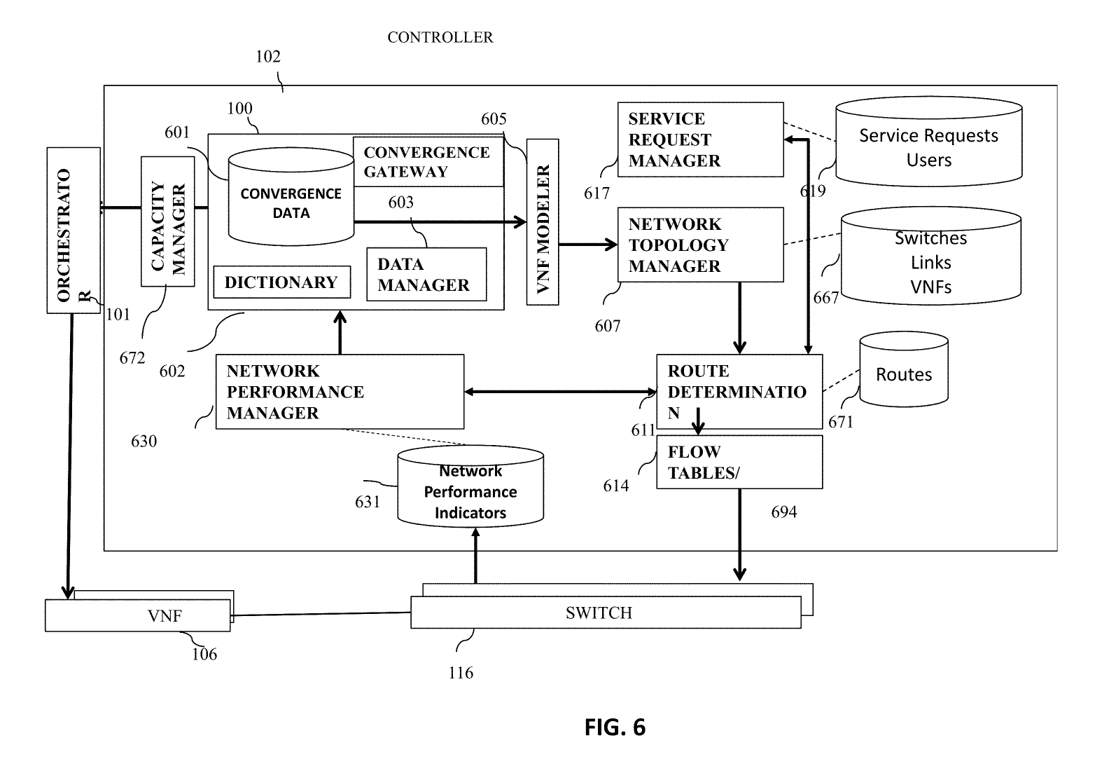

FIG. 6 shows an exemplary embodiment of controller 102 with resident convergence gateway functionality 100. The Convergence Database 601 stores the information model illustrated in FIG. 4. The information is refreshed as there are changes in the network. The convergence gateway has an optional data dictionary 602, which can translate from one system's information model to the other. It also has data manager 603, which receives updates from orchestrator 101 and controller 102 and refreshes convergence gateway data 601. Service request manager 617 manages users and their service requests. The related data is stored in service request database 619.

VNF Modeler 605 maps each active VNF into a so called ‘virtual switch’ or a ‘virtual link’, and feeds it into topology manager 607 to extend the network topology to incorporate the NFV functionality. The overall network topology with network nodes that contain network switches and ‘virtual switches’ are stored in database 667. The virtual switch topology is essentially overlaid on top of the physical network topology. The topology database also has other topological information such as the grouping of the virtual switches according to the type of service they provide, and the status of each network switch and virtual switch.

Capacity Manager 672 feeds information to the Orchestrator when the VNF capacity has to be increased or shifted to other parts of the SDN when there is a sustained major network congestion and/or catastrophic event impacting certain network nodes or facilities.

Route determination 611 calculates best routes for data flows when there is service chaining and stores these routes in database 671. In turn, flow table 614 generates flow tables, stores them in database 694 and sends them to network switch(es) 116 using an interface such as OpenFlow. When switch 116 forwards a request for a route for a specific data flow by sending say a packet-in message, the request travels through service request manager 617 to validate the user and the service type, route determination 611 determines the route and flow tables 614 determines the corresponding flow tables.

Route determination uses network topology database, the information in service requests such as service level agreements, and network policies to determine the best route.

Prior-art shortest path routing techniques, which are algorithmic, would be directly applicable to determine the best path for a data flow across many switches and VNFs. Given the problem in hand is NP-complete, the algorithms that may simply enumerate several feasible alternative paths and select the one solution that satisfies the optimal value for a specific cost function can be used. The routing algorithm can consider, for example, each VNF's processing capacity as a constraint on the virtual link. When a VNF is congested, the algorithm must avoid using it, just like avoiding congested facilities.

Routing for Service Chaining Use-Case:

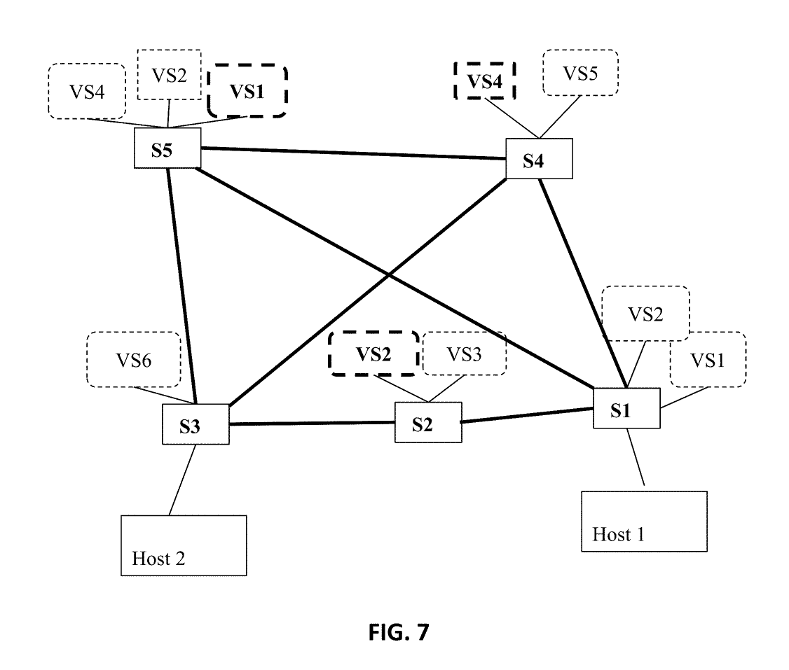

A simple flow-routing scenario with service chaining is described in this section as a use-case. FIG. 7 illustrates a simple example SDN with five network switches S1, S2, S3, S4 and S5 with five virtualized network functions, VNF-1 through VNF-5, distributed across the SDN, and modeled as virtual switches VS1 through VS5, respectively. These functions can reside on physical servers attached to switches. Several network functions have multiple presences in the network. For example, VNF-1 (represented as VS1) is available at the network nodes of switches S1 and S5, and VNF-2 (represented as VS2) is available at network nodes of S1, S2 and S5 giving multiple location options to receive these services.

Let us assume that a service request is a packet flow originating from Host-1 and destined to Host-2 while receiving services VS1 and then VS4 along the way. To complicate the scenario, let us assume that the services S5-VS1, S2-VS2 and S4-VS4 are congested (illustrated as shaded boxes in FIG. 7). Note that those virtual switches that have congested service can simply be eliminated from the topology during their congested state, given they can't be used to service more data flows.
a) The shortest path from Host-1 to Host-2 is:
   {Host 1-S1-S2-S3-Host 2}
b) VS1 is available at S1, but VS4 isn't available along the shortest path. Thus, the shortest path is not a feasible path.
c) VS1 is only available at S1 and S5. But, S5-VS1 is congested (eliminate it from the topology). Therefore, the only option of VS1 is S1-VS1.
d) VS4 is only available at S4 and S5. But, S4-VS4 is congested (eliminate it from the topology). Therefore, the only option for VS4 is S5-VS4. Thus, the route from Host-1 to Host-2 must traverse S1 to receive the service of VS1 and S5 to receive the service of VS4. The only feasible path satisfying these constraints is therefore,
   {Host 1-(S1-VS1)-(S5-VS4)-□S3-□Host 2}
e) The forwarding tables according to the route determined in d) are sent by the controller to S1, S5 and S3.

In one embodiment, the present invention provides an article of manufacture having non-transitory computer readable storage medium comprising computer readable program code executable by a processor in a convergence gateway attached to a controller that is part of a software defined network (SDN), the controller controlling a plurality of network switches that are part of the SDN, the network switches associated with one or more virtualized network functions (VNFs), the VNFs being managed by an orchestrator, with a first network switch connected to a first host and a second network switch connected to a second host, the medium comprising: (a) computer readable program code collecting and storing data pertaining to: (i) status of the network switches and one or more links interconnecting the network switches forming a topology of the SDN, and network congestion and available capacity information on all physical and virtualized network resources of the SDN; (ii) VNFs associated with each of the network switch, and data relating to capacity and congestion status associated with each VNF; and (b) computer readable program code determining a routing path via any one of the following ways: (i) of at least one packet flow between the first host and second host, where the routing path traverses, as part of the packet flow between the first host and second host, at least one of the network switches and at least one of the requested VNFs; (ii) determining a routing path of at least one packet flow between either the first or second host and a requested VNF, where the routing path traverses, as part of the packet flow between either the first or second host and the requested VNF associated with one of the network switches; or (iii) determining a routing path of at least one packet flow between either the first or second host and a first requested VNF, where the routing path traverses, as part of the packet flow between either the first second host and the first requested VNF, at least one of the network switches and a second requested VNF associated with that switch.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable BluRay® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to controllers or processors that may execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for the effective implementation of a system and method for convergence of software defined network (SDN) and network function virtualization (NFV). While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A system comprising:
a convergence gateway attached to a controller that is part of a software defined network (SDN), the controller controlling a plurality of network switches that are part of the SDN, with a first network switch connected to a first host and a second network switch connected to a second host;
one or more virtualized network functions (VNFs) associated with each of the network switches;
an orchestrator managing the VNFs,
wherein the convergence gateway performs:
collecting and storing data pertaining to: (a) status of the network switches and one or more links interconnecting the network switches forming a topology of the SDN, and network congestion and available capacity information on all physical and virtualized network resources of the SDN; (b) VNFs associated with each of the network switch, and data relating to capacity and congestion status associated with each VNF; and
determining a routing path via any one of the following ways: (1) of at least one packet flow between the first host and second host, where the routing path traverses, as part of the packet flow between the first host and second host, at least one of the network switches and at least one of the VNFs; (2) determining a routing path of at least one packet flow between either the first or second host and a requested VNF, where the routing path traverses, as part of the packet flow between either the first or second host and the requested VNF associated with one of the network switches; or (3) determining a routing path of at least one packet flow between either the first or second host and a first VNF, where the routing path traverses, as part of the packet flow between either the first second host and the first VNF, at least one of the network switches and a second requested VNF associated with that switch.

2. The system of claim 1, wherein at least one VNF associated with a given network switch is implemented via any of the following: as part of the given network switch's hardware or in a server that is in communication with the given network switch.

3. The system of claim 1 further comprising:
a data collector, which (i) collects data in real-time from the network switches and VNFs, and (ii) associates the collected data using an information model;
a database, which stores the information model associated with the collected data;
a topology manager, which overlays the VNFs onto a physical network topology;
a route determiner, which determines the best routing path of packet flows across the network switches and the VNFs using the physical network topology generated by the topology manager; and
and a capacity manager, which determines locations of new VNFs considering the physical network topology.

4. The system of claim 3, wherein the information model associates attributes of data related to the SDN and the VNFs.

5. The system of claim 4, wherein the model associates any of the following: (i) VNF interfaces to physical network switch interfaces, (ii) locations of VNFs to locations of the network switches, (iii) congestion to VNF, facilities, ports and switches, and (iii) service requests to VNFs.

6. The system of claim 3, wherein the information mode is the Common Information Model.

7. The system of claim 1, wherein the convergence gateway is co-resident with any of the following: the controller and the orchestrator.

8. The system of claim 1, wherein the convergence gateway, the orchestrator, and the controller are implemented as one unit.

9. The system of claim 1, wherein the convergence gateway selects a routing path for at least one data flow visits at least one VNF between a source host and a destination host of the data flow, wherein the at least one VNF is available only at certain network switches within the plurality of network switches.

10. The system of claim 9, wherein the selecting the routing path is performed: (a) using an algorithmic method, or (b) by enumerating all alternative paths.

11. The system of claim 10, wherein the algorithmic method selects network switches for the virtual function visitation by minimally deviating from a shortest path between the source host and the destination host.

12. The system of claim 9, wherein route path selection avoids those network nodes in which the co-located VNF is congested or unable to serve required data flows.

13. The system of claim 1, wherein the convergence gateway select a routing path for (i) at least one data flow that originates at a source host and destined to a requested VNF among all VNFs, and (ii) there may be zero, one, or more other requested VNF visitations along the selected routing path between a source host and a destination host.

14. The system of claim 13, wherein routing path selection is performed: (a) using an algorithmic method, or (b) by enumerating all alternative paths.

15. The system of claim 14, wherein the algorithmic method prefers a routing path which minimally deviates from the shortest path.

16. The system of claim 15, wherein route path selection avoids those network nodes in which a requested VNF is congested or unable to serve required data flows.

17. A method as implemented in a convergence gateway attached to a controller that is part of a software defined network (SDN), the controller controlling a plurality of network switches that are part of the SDN, the network switches associated with one or more virtualized network functions (VNFs), the VNFs being managed by an orchestrator, with a first network switch connected to a first host and a second network switch connected to a second host, the method comprising:
collecting and storing data pertaining to: (a) status of the network switches and one or more links interconnecting the network switches forming a topology of the SDN, and network congestion and available capacity information on all physical and virtualized network resources of the SDN; (b) VNFs associated with each of the network switch, and data relating to capacity and congestion status associated with each VNF; and
determining a routing path via any one of the following ways: (1) of at least one packet flow between the first host and second host, where the routing path traverses, as part of the packet flow between the first host and second host, at least one of the network switches and at least one of the requested VNFs; (2) determining a routing path of at least one packet flow between either the first or second host and a requested VNF, where the routing path traverses, as part of the packet flow between either the first or second host and the requested VNF collocated with one of the network switches; or (3) determining a routing path of at least one packet flow between either the first or second host and a first VNF, where the routing path traverses, as part of the packet flow between either the first second host and the first VNF, at least one of the network switches and a second requested VNF associated with that switch.

18. The method of claim 17, wherein at least one VNF associated with a given network switch is implemented via any of the following: as part of the given network switch's hardware or in a server that is in communication with the given network switch.

19. The method of claim 16, wherein the convergence gateway is co-resident with any of the following: the controller and the orchestrator.

20. The method of claim 16, wherein the convergence gateway, the orchestrator, and the controller are implemented as one unit.

21. An article of manufacture having non-transitory computer readable storage medium comprising computer readable program code executable by a processor in a convergence gateway attached to a controller that is part of a software defined network (SDN), the controller controlling a plurality of network switches that are part of the SDN, the network switches associated with one or more virtualized network functions (VNFs), the VNFs being managed by an orchestrator, with a first network switch connected to a first host and a second network switch connected to a second host, the medium comprising:
computer readable program code collecting and storing data pertaining to: (a) status of the network switches and one or more links interconnecting the network switches forming a topology of the SDN, and network congestion and available capacity information on all physical and virtualized network resources of the SDN; (b) VNFs associated with each of the network switch, and data relating to capacity and congestion status associated with each VNF; and
computer readable program code determining a routing path via any one of the following ways: (1) of at least one packet flow between the first host and second host, where the routing path traverses, as part of the packet flow between the first host and second host, at least one of the network switches and at least one of the requested VNFs; (2) determining a routing path of at least one packet flow between either the first or second host and a requested VNF, where the routing path traverses, as part of the packet flow between either the first or second host and the requested VNF associated with one of the network switches; or (3) determining a routing path of at least one packet flow between either the first or second host and a first requested VNF, where the routing path traverses, as part of the packet flow between either the first second host and the first requested VNF, at least one of the network switches and a second requested VNF associated with that switch.
